(19) United States
(12) Patent Application Publication
(10) Pub. No.: US 2025/0314129 A1
(43) Pub. Date: Oct. 9, 2025

(54) TENSIONER FOR A ROLLER SHADE

(71) Applicant: ZMC Metal Coating Inc., Woodbridge (CA)

(72) Inventor: Philip NG, Woodbridge (CA)

(73) Assignee: ZMC Metal Coating Inc., Woodbridge (CA)

(21) Appl. No.: 19/073,740

(22) Filed: Mar. 7, 2025

Related U.S. Application Data
(60) Provisional application No. 63/574,946, filed on Apr. 5, 2024.
(60) Provisional application No. 63/660,830, filed on Jun. 17, 2024.

(51) Int. Cl. E06B 9/90; E06B 9/42; E06B 9/78; E06B 9/80

(52) U.S. Cl. CPC E06B 9/90; E06B 9/42; E06B 9/78; E06B 2009/785; E06B 2009/801

(57) ABSTRACT

The tensioner is mounted in use to a vertical surface for throughpassage in taut relation of a clutch actuator selected from ball chain and cord and comprises a lock arrangement which: includes a plunger having a bearing surface; and, in use, is adapted to arrest throughpassage of the actuator in slack conditions. The plunger, in use, is: (i) adapted for vertical movement between an extended position and a retracted position that is elevated in relation to the extended position; adapted, when in the retracted position, to receive the actuator in the manner of a pulley, for smooth operation of the shade; and biased for movement towards the extended position. The lock arrangement is adapted, in use: upon movement of the plunger to the extended position, to arrest movement of the plunger towards the retracted position; and, when the plunger is in the extended position, to arrest throughpassage of the actuator.

### CROSS-REFERENCE TO RELATED APPLICATONS

This application claims priority to U.S. Provisional Patent Application Ser. No. 63/574,946, filed Apr. 5, 2024, and U.S. Provisional Patent Application Ser. No. 63/660,830, filed Jun. 17, 2024, both incorporated herein by reference.

### FIELD

The invention relates to the field of roller shades.

### BACKGROUND

Improving the safety of roller shades is desirable.

### SUMMARY

Forming one aspect of the invention is a tensioner for a roller shade, the tensioner being of the type mounted in use to a vertical surface for throughpassage in taut relation of a clutch actuator selected from ball chain and cord.

The tensioner comprises: a lock arrangement which, in use, is adapted to arrest throughpassage of the actuator in the event of slack.

According to another aspect, the lock arrangement can:
include a plunger having a bearing surface, the plunger, in use,
   being adapted for vertical movement between: an extended position; and a retracted position that is elevated in relation to the extended position;
   being adapted, when in the retracted position, to receive the actuator in the manner of a pulley, for smooth operation of the shade; and
   being biased for movement towards the extended position,
be adapted, in use, upon movement of the plunger to the extended position, to arrest movement of the plunger towards the retracted position; and
be adapted, in use, when the plunger is in the extended position, to arrest throughpassage of the actuator.

According to another aspect:
the tensioner can be biased for movement towards the extended position;
the lock arrangement, upon movement of the plunger to the extended position, can arrest movement of the plunger towards the retracted position;
the lock arrangement, when the plunger is in the extended position, can arrest throughpassage of the actuator; and
the lock arrangement can include a release that selectively allows movement of the plunger toward the retracted position from the extended position.

According to another aspect, the tensioner can further comprise a backer and a cover and the lock arrangement can comprise a passage defined in one of the backer and the cover and a resilient finger carried by plunger, the passage including a socket that presents interiorly and a keyway that presents exteriorly, the resilient finger springing into the socket when the plunger reaches the extended position.

According to another aspect, the deformable finger can define the release.

According to another aspect, the tensioner can further comprise a spring that biases the plunger for movement towards the extended configuration.

According to another aspect, the lock arrangement can further comprise a jaw which, in combination with the plunger, grips the actuator when the plunger is in the extended position.

According to another aspect, the jaw can have a ball shaped hollow for use with a ball chain.

According to another aspect, the jaw can have gripping teeth for use with a cord.

According to another aspect, the plunger can have a cavity and the jaw can have a portion that is received by the cavity when the plunger is in the extended position.

According to another aspect, the passage can be defined in the cover.

Further advantages, features and characteristics will become evident upon a review of the following detailed description, with reference to the appended claims, the latter being briefly described hereinafter.

### BRIEF DESCRIPTION OF THE DRAWINGS

In the drawings:

FIG. 1 is a view of an example tensioner according to the invention;

FIG. 2 is a front exploded view of the structure of FIG. 1;

FIG. 3 is a rear exploded view of the structure of FIG. 1;

FIG. 4 is a view of the structure of FIG. 1 in use with a roller shade;

FIG. 5 is an enlarged view of detail M of FIG. 4;

FIG. 6 is a front view of the structure of FIG. 5;

FIG. 7 is a view along section 7-7 of FIG. 6, showing the plunger in the retracted position;

FIG. 8 is a view similar to FIG. 7, with the plunger in the extended position;

FIG. 9 is a view similar to FIG. 7, with the plunger locked at the extended position;

FIG. 10 is a view similar to FIG. 6, with the plunger locked at the extended position;

FIG. 11 is a view along section 11-11 of FIG. 10;

FIG. 12 is a view similar to FIG. 11 with the plunger unlocked;

FIG. 13 is a side view of the structure of FIG. 10 with the plunger at the retracted position and a mounting spacer installed;

FIG. 14 is view of the structure of FIG. 13 about to be mounted to a wall;

FIG. 15 is a front view of a tensioner according to another embodiment of the invention;

FIG. 16 is a view along section 16-16 of FIG. 15;

FIG. 17 is an exploded view of the structure of FIG. 15;

FIG. 18.1 is a front view of a tensioner according to another embodiment of the invention in receipt of a cord;

FIG. 18.2 is an exploded view of the tensioner of FIG. 18.1;

FIG. 18.3 is an enlarged view of the structure indicated by 18.3 of FIG. 18.2;

FIG. 18.4 is an enlarged view of the structure indicated by 18.4 of FIG. 18.2;

FIG. 18.5 is an enlarged view of the structure by 18.5 of FIG. 18.2;

FIG. 18.6 is a view along 18.6-18.6 of FIG. 18.1;

FIG. 18.7 is a view along 18.7-18.7 of FIG. 18.6;

FIG. 18.8 is a right side view of the tensioner of FIG. 18.1; and

FIG. 18.9 is a view along 26-26 of FIG. 18.8.

### DETAILED DESCRIPTION

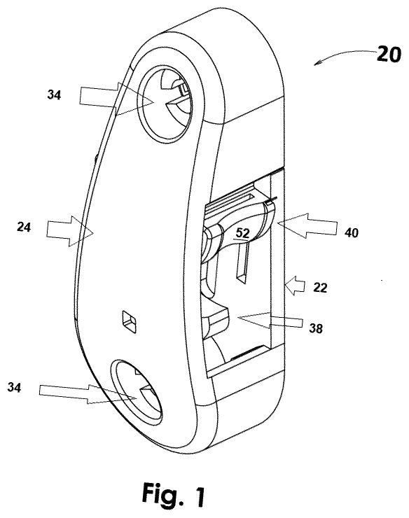

A tensioner 20 for a roller shade according to an example embodiment of the invention is shown in FIG. 1.

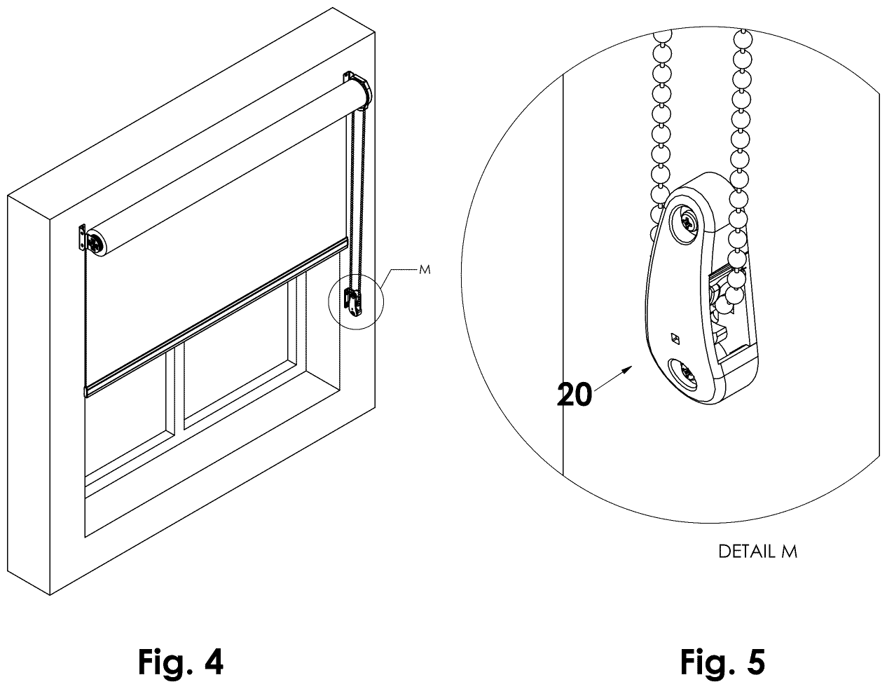

As seen in FIGS. 4 and 5, the tensioner is of the type mounted in use to a vertical surface for throughpassage in taut relation of a clutch actuator, namely, a ball chain 21.

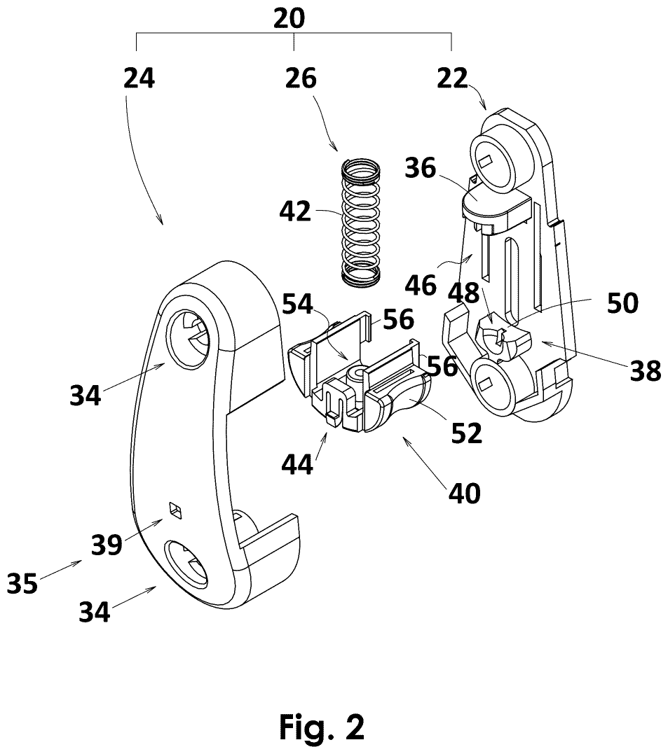

The tensioner 20 is shown in exploded view in FIG. 2 and will be understood to comprise a backer 22, a cover 24 and a lock arrangement 26.

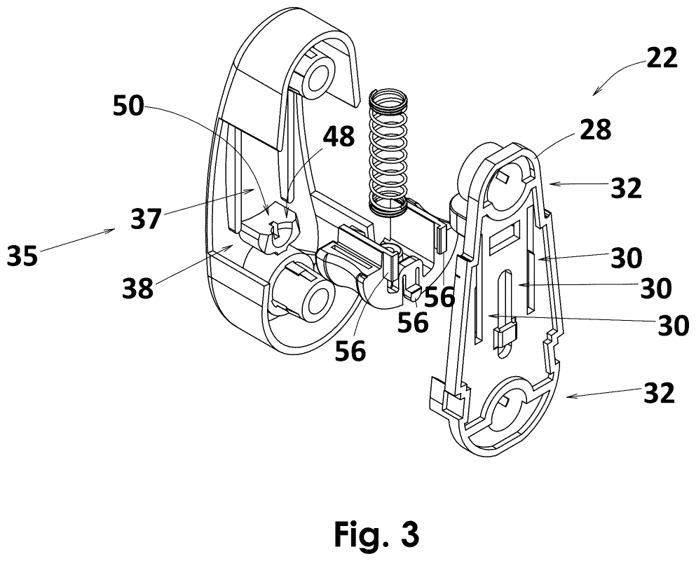

As indicated in FIG. 3, the backer 22 comprises a plate 28 having a trio of spaced apart slots 30 and a pair of spaced apart holes 32.

As indicated in FIGS. 2 and 3, the cover 24 has a pair of bores 34 which communicate with the holes 32 in the backer 22 and is disposed in snap fit engagement therewith. The cover 24 further defines a passage 35, the passage 35 including a socket 37 that presents interiorly and a keyway 39 that presents exteriorly.

The lock arrangement 26 comprises a bracket 36, a jaw 38, a plunger 40, a spring 42 and a resilient finger 44.

The bracket 36 protrudes from the plate 28 above the slots 30 and has a cylindrical downwardly-presenting socket 46. The jaw 38 is defined by mating parts formed, respectively, on the cover 24 and the backer 22, and defines a hemispherical upwardly-presenting hollow 48. The jaw 38 also has an upwardly-presenting and upwardly tapering slot 50. The various parts of jaw 38, socket 46 and hollow 48 are shown in FIGS. 2 and 3.

The plunger 40 has an arcuate bearing surface 52, an upwardly presenting socket 54 and a trio of slides 56, each slide 56 protruding through a respective one of the slots 30.

The spring 42 is disposed in captured relation between the plunger 40 and the bracket 36, engaging, respectively, the upwardly-presenting socket 54 and the downwardly-presenting socket 46.

The finger 44 is carried by the plunger 40.

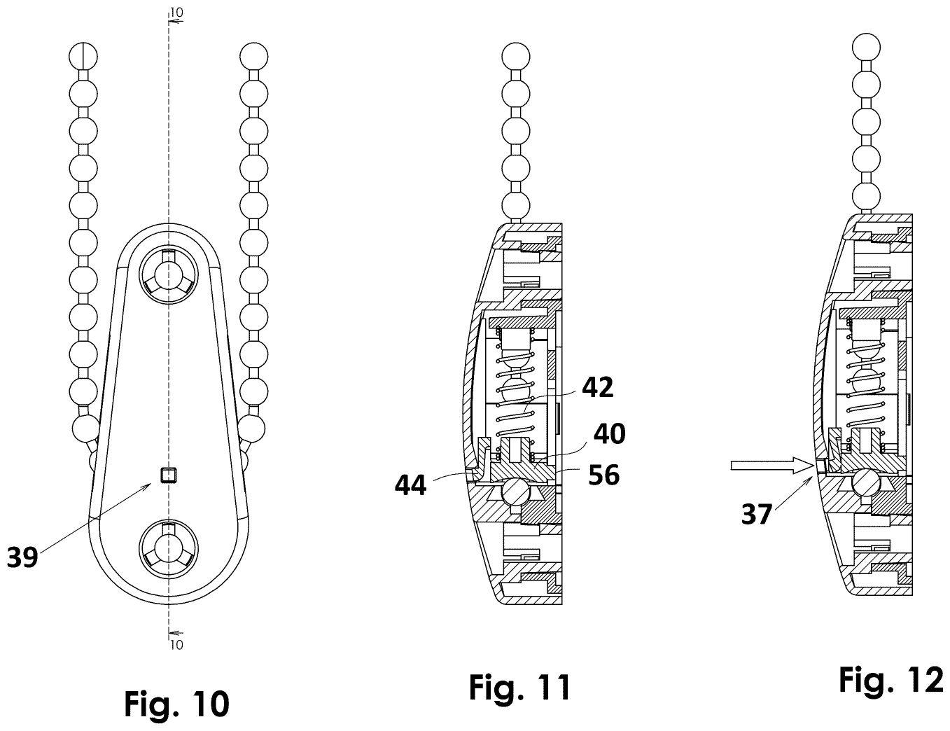

Pre-installation: the plunger 40 will be locked in an extended position, as shown in FIGS. 10 and 11, having been urged thereto by force of the spring 42; and the tensioner 20 will be locked to the chain 21 by virtue of a grip provided by the combination of the plunger 40, the jaw 38 and the hollow 48 in the jaw 38 that captures a ball of the chain 21.

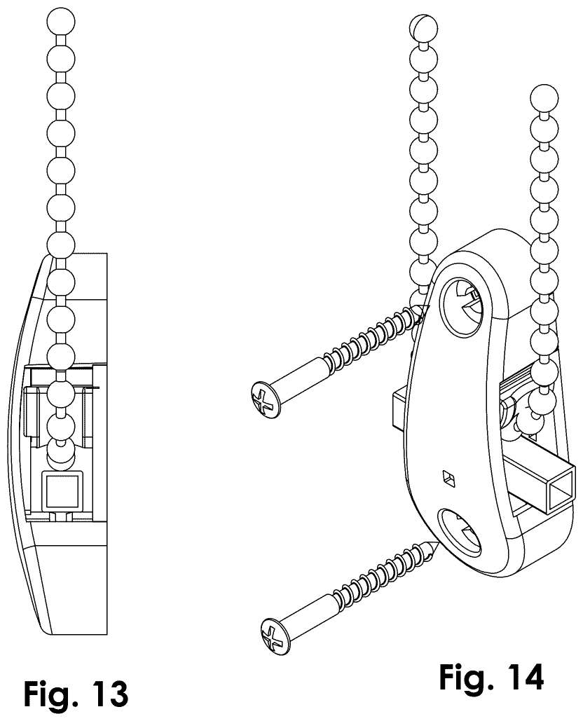

To install the tensioner 20, the finger 44 will be manipulated, by inserting a pin or pointed objected, into the keyway 39, to clear the finger 44 from the socket 37, as indicated by FIGS. 11, 12, thereby allowing movement of the plunger 40 to the retracted position, as indicated by FIGS. 12, 13. This can be done by urging the tensioner 20 against the chain. Then a mounting bar is inserted between the chain 21 and the jaw, as indicated in FIGS. 13 and 14. The tensioner 20 can then be mounted to the wall, by driving screws through the apertures in the housing and backer, and the bar removed.

So installed, the tension provided by the ball chain 21 against the bearing surface 52 ensures that the plunger 40 is maintained in the retracted position against the force of the spring. However, should the tensioner loosen from the wall, thereby creating slack in the ball chain, the plunger is urged by the spring towards the extended position, whereupon the finger springs out into the socket, to lock the plunger in the extended position and the chain between the plunger and the jaw.

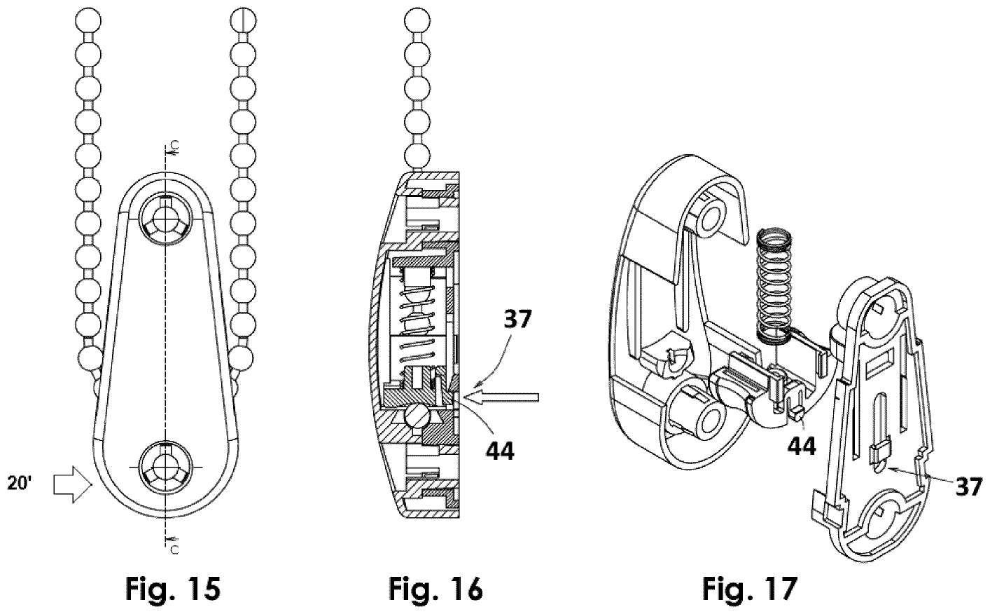

FIGS. 15-17 shows another embodiment 20′ of the invention that differs in that the passage is formed in the backer and the resilient finger is on the back side of the plunger.

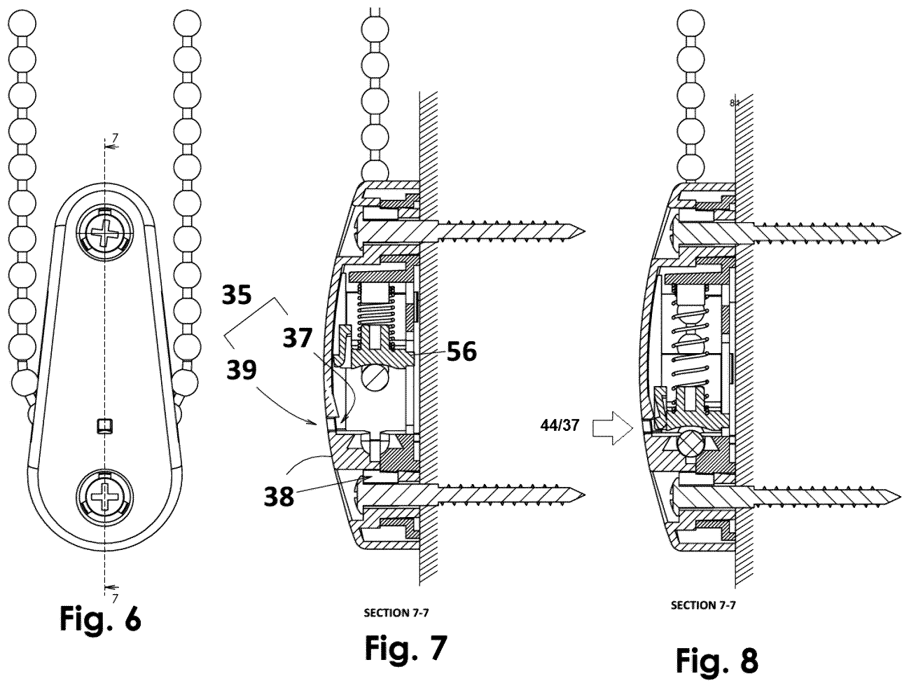

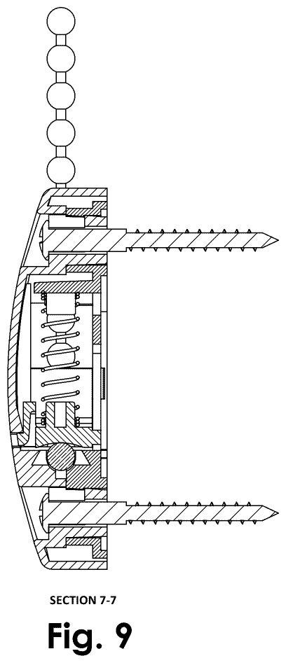

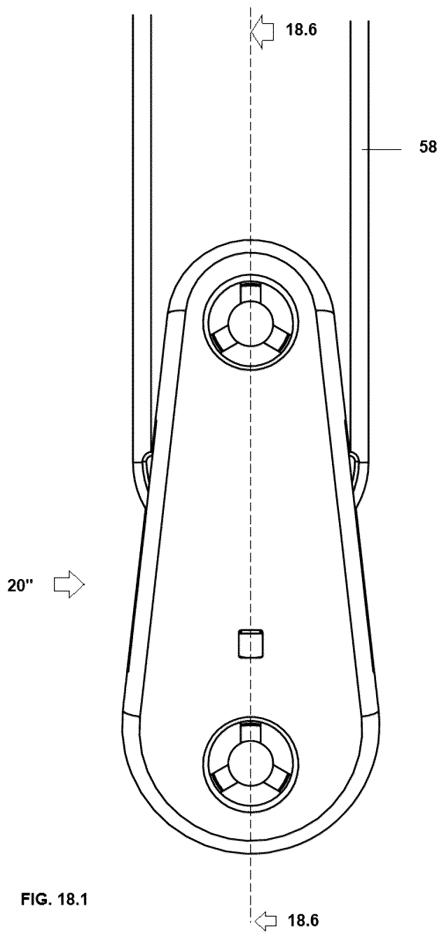

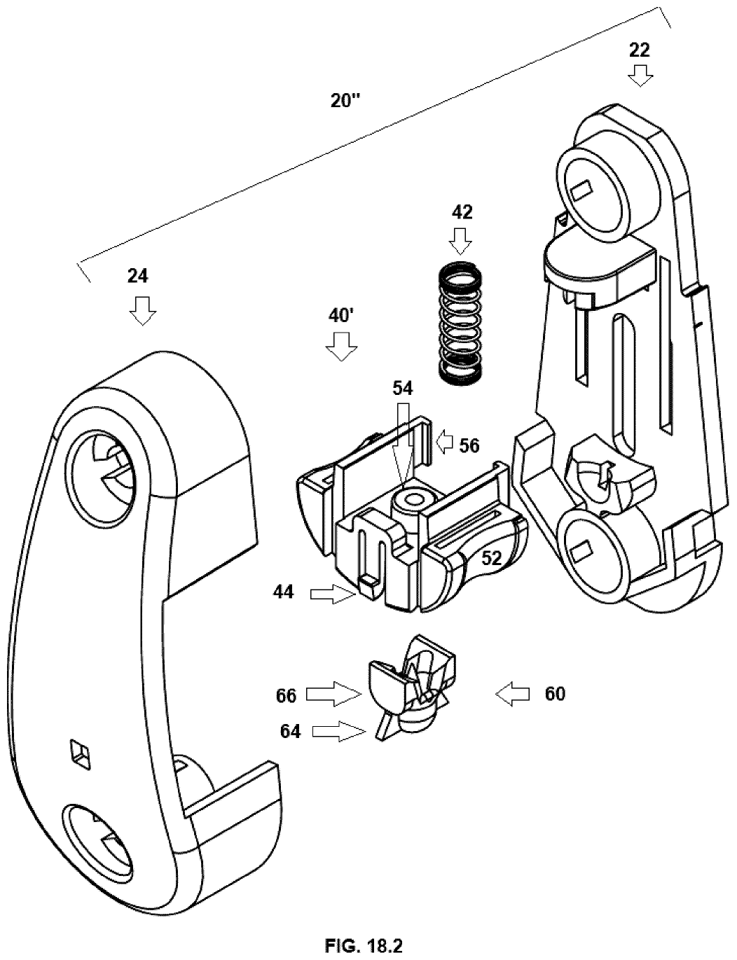

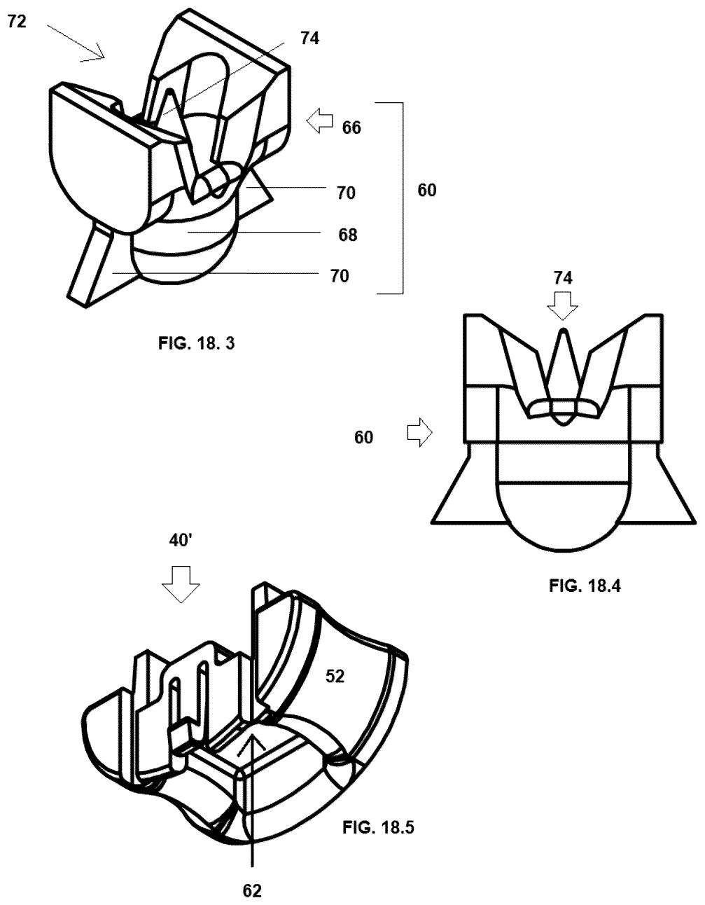

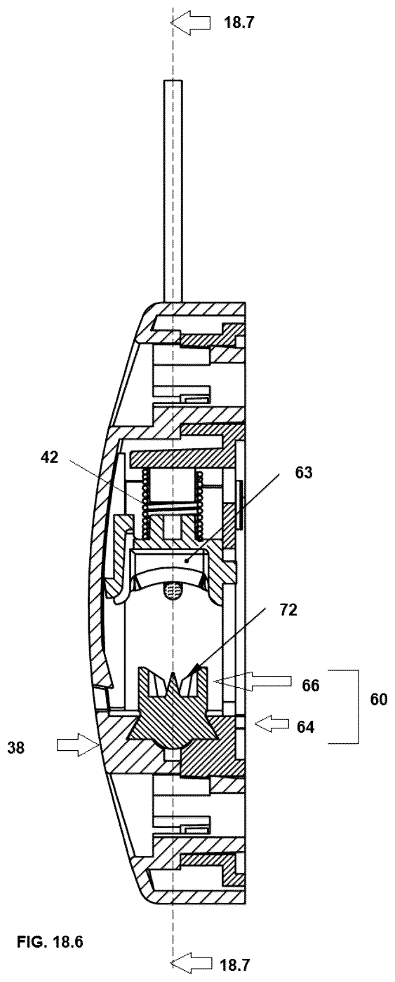

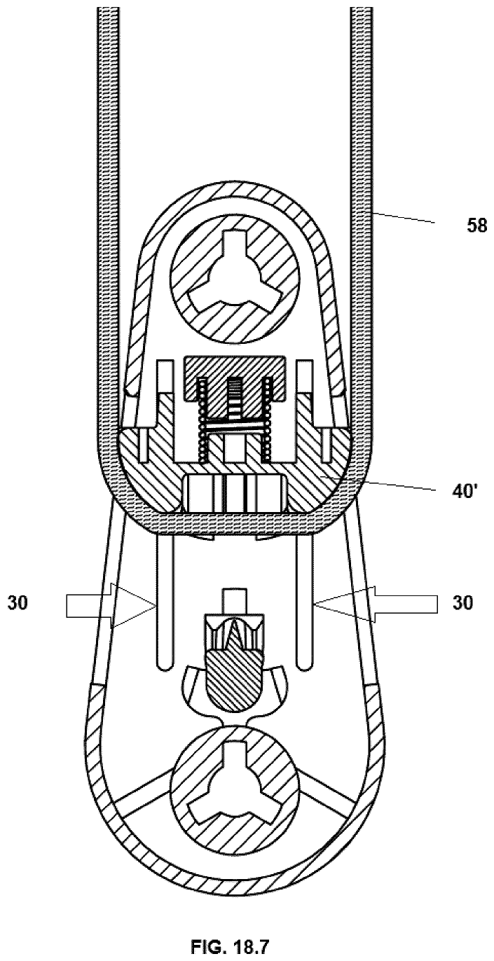

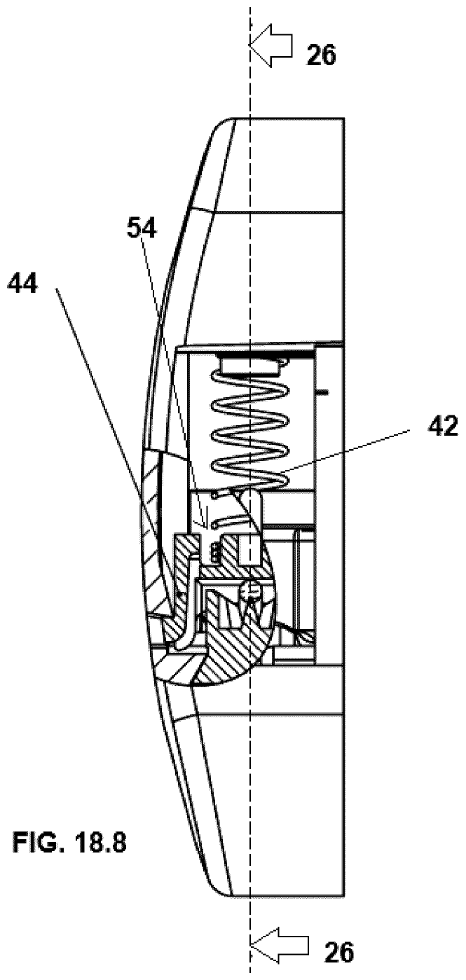

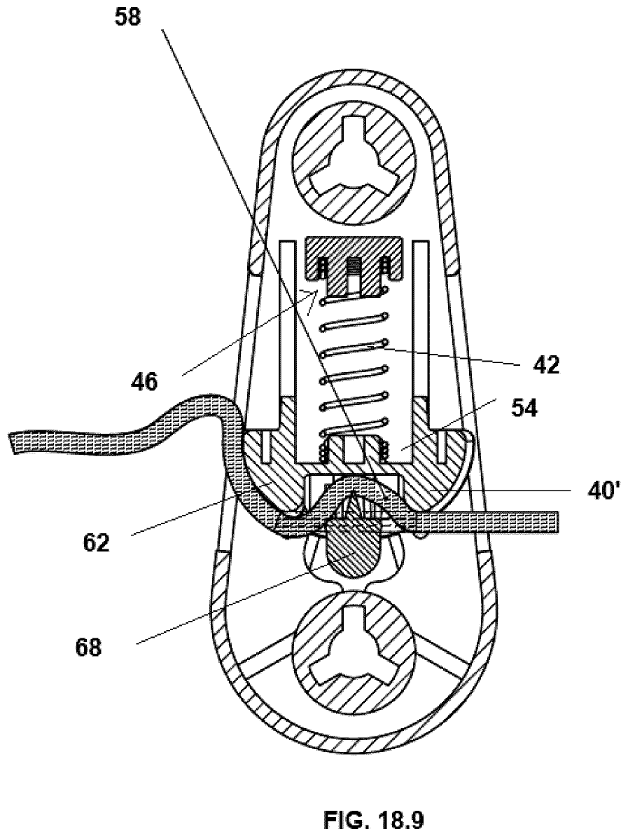

FIGS. 18.1 to 18.9 show another embodiment 20″ of the invention. This embodiment 20″ differs from that of FIG. 6 in that it has a modified plunger 40′ and a gripping tooth 60 and is for use with a cord 58 as shown in FIG. 18.1.

Modified plunger 40′ differs from plunger 40 in that it includes a cavity 62 formed in an underside thereof, as best indicated in FIG. 18.5.

Gripping tooth 60 has a base 64 and a body 66. The base 64 is defined by a bulbous central portion 68 and opposed angular portions 70. The body 66 defines a slot 72 and centrally of the slot a conical tooth 74. In use, the bulbous central portion 68 of the base is received by hollow 48 of the jaw and the opposed angular portions 70 are received in captured relation by the tapering slot 50 such that conical tooth 74 projects vertically.

In this embodiment, when plunger 40′ is urged by the spring towards the extended position, the cord is locked between the plunger and the jaw, more particularly, the cord passes through the slot in the jaw, with a meander about the tooth, as indicated by FIG. 18.9. Embodiment 20′ otherwise is structurally and functionally identically as embodiment 20′, with equivalent parts bearing the same number.

Whereas a specific embodiment is herein shown and described, it will be evident that variations are possible. Without limitation in this regard:
the shuttle could carry a rotatably mounted pulley rather than the arcuate bearing surface:
a leaf type spring could be substituted for the coil spring;
the backer plate could be mounted to the wall and the cover could be snap fit thereover after installation.

Accordingly, the invention should be understood to be limited only by the accompanying claims, purposively construed.

1. A tensioner for a roller shade, the tensioner being of the type mounted in use to a vertical surface for throughpassage in taut relation of a clutch actuator selected from ball chain and cord, the tensioner comprising:
a lock arrangement which, in use, is adapted to arrest throughpassage of the actuator in the event of slack.

2. The tensioner of claim 1, wherein the lock arrangement:
includes a plunger having a bearing surface, the plunger, in use,
being adapted for vertical movement between
an extended position and
a retracted position that is elevated in relation to the extended position
being adapted, when in the retracted position, to receive the actuator in the manner of
a pulley, for smooth operation of the shade; and
being biased for movement towards the extended position
is adapted, in use, upon movement of the plunger to the extended position, to arrest movement of the plunger towards the retracted position; and
is adapted, in use, when the plunger is in the extended position, to arrest throughpassage of the actuator.

3. The tensioner of claim 2, wherein:
the plunger is biased for movement towards the extended position;
the lock arrangement, upon movement of the plunger to the extended position, arrests movement of the plunger towards the retracted position;
the lock arrangement, when the plunger is in the extended position, arrests throughpassage of the actuator; and
the lock arrangement includes a release, that selectively allows movement of the plunger toward the retracted position from the extended position.

4. The tensioner of claim 3, wherein the tensioner comprises a backer and a cover and wherein the lock arrangement comprises a passage defined in one of the backer and the cover and a resilient finger carried by the plunger, the passage including a socket that presents interiorly and a keyway that presents exteriorly, the resilient finger springs into the socket when the plunger reaches the extended position.

5. The tensioner of claim 4, wherein the deformable finger defines the release.

6. The tensioner of claim 1, further comprising a spring that biases the plunger for movement towards the expanded configuration.

7. The tensioner of claim 1, wherein the lock arrangement further comprising a jaw which, in combination with the plunger, grips the actuator when the plunger is in the extended position.

8. The tensioner of claim 7, wherein the jaw has a ball shaped hollow for use with a ball chain.

9. The tensioner of claim 7, wherein the jaw has gripping teeth for use with a cord.

10. The tensioner of claim 9, wherein the gripping teeth are removable.

11. The tensioner of claim 4, wherein the passage is defined in the cover.
